(19) United States
(12) Patent Application Publication
(10) Pub. No.: US 2009/0269948 A1
(43) Pub. Date: Oct. 29, 2009

(54) ELECTRONIC DEVICE MODULE

(75) Inventors: Gerard Nemoz, Maisons Alfort (FR); Olivier Leborgne, Garancieres (FR)

Correspondence Address: LOWE HAUPTMAN HAM & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 11/722,319

(22) PCT Filed: Nov. 14, 2005
(86) PCT No.: PCT/EP05/55941

§ 371 Date: Jun. 20, 2007

(30) Foreign Application Priority Data
Dec. 20, 2004 (FR) 0413585

(51) Int. Cl. H01R 12/00

(52) U.S. Cl. 439/65

(57) ABSTRACT

The present invention relates to an electronic device module into which at least one printed circuit card is plugged. The electronic device module (1) comprises a first connector (4) mounted on one face (3) of the module (1), the first connector (4) being provided with electrical contacts each having an end (6) internal to the module and an end (5) external to the module, the external ends (5) being designed to be plugged into a rack, the internal ends (6) being designed to be soldered, wire-wrapped or crimped, the module (1) furthermore including at least one plugged-in printed circuit card (7, 9; 18, 19), the printed circuit card (7, 9; 18, 19) being electrically connected to the internal ends (6). According to the invention, the electronic device module (1) includes a second connector (8, 10; 20, 21) that is rigidly fastened to the printed circuit card (7, 9; 18, 19) and is plugged into the internal ends (6).

### CROSS-REFERENCE TO RELATED APPLICATIONS

The present Application is based on International Application No. PCT/EP2005/055941, filed on Nov. 14, 2005, which in turn corresponds to France Application No. 04 13585 filed on Dec. 20, 2004, and priority is hereby claimed under 35 USC §119 based on these applications. Each of these applications are hereby incorporated by reference in their entirety into the present application.

### FIELD OF THE INVENTION

The present invention relates to an electronic device module into which at least one printed circuit card is plugged. It relates more particularly to a plug-in electronic device module that is mounted removably in a rack and is equipped on one of its faces with at least one connector intended to be connected to a complementary connector. The complementary connector is mounted on a backplane of the rack in order to ensure that the electronic devices of the module are electrically connected to the external environment in which they are intended to operate. This type of module is routinely used in the aeronautical industry, for example for producing onboard computers.

### DESCRIPTION OF THE PRIOR ART

Plug-in electronic device modules have the benefit of facilitating the maintenance and troubleshooting of an electronic system, the elements of which are distributed between several modules, facilitating replacement operations by making standard exchanges at module level. A rack and a module may be exposed to harsh mechanical or thermal environments. The connectors for ensuring connection between rack and module are mounted in a rack backplane. They comprise electrical through-contacts connecting the inside of the module to the outside. The connectors must also withstand the same environments. There are recognized standards for guaranteeing the integrity of standard connectors in such environments. Rack manufacturers rely on these standards to ensure that the connectors that equip their racks withstand difficult usage conditions such as, for example, those encountered when fitting a module in a space with limited access. It will be recalled here that a standard connector is a connector that meets the standards for withstanding the harsh environments required by rack manufacturers, and the ends of the contacts of such a connector, which are located inside the module, are designed to be irremovably connected. In order for a module to be plugged into a rack, it is necessary for the module to be complementary to the connector mounted on a backplane of the rack and for it to meet the same standards for withstanding the environments as said rack. However, the only connectors that meet these standards have components whose electrical contact ends located inside the module are designed to be irremovably connected. The term “irremovable connection” is understood to mean a connection that cannot be disconnected without a tool, for example a wire-wrapped, crimped or soldered connection. A wire-wrapped connection is produced by wrapping a stripped single-strand wire around one end of an electrical contact, generally of square cross section. In addition, plug-in printed circuit cards have the benefit of facilitating the maintenance and troubleshooting of electronic systems, the elements of which are distributed between several printed circuit cards, facilitating replacement operations by a standard exchange at printed circuit card level. It is therefore preferable to use modules that can be plugged into racks, into which modules the printed circuit cards can be plugged.

A first solution for producing such modules consists in developing a novel connector intended for fitting into modules. This has electrical through-contacts and meets the standards for withstanding the harsh environments imposed by rack manufacturers. Its particular feature lies in the fact that the ends of the contacts that are located inside the module are designed so that the printed circuit cards plug directly into them: this solution is very expensive as regards the quantities of connectors involved.

A second solution consists in developing an interconnection unit having electrical contacts, each contact having two ends. One of the ends of the contacts is irremovably connected to the connector of the module, for example by soldering to a printed circuit of the interconnection unit. The other end of the contacts is removably connected to the contacts of the printed circuit card. In other words, the printed circuit card is plugged into the other end of the contacts of the interconnection unit. The size of the interconnection unit is large when the number of contacts that its supports exceeds around 100, the space that it occupies in the module then limiting the area of the printed circuit card.

The present invention alleviates the drawbacks of the two solutions presented above. The object of the invention is to equip the back of a module with a standard connector without requiring the use of any interconnection unit for plugging a printed circuit card into the module.

### SUMMARY OF THE INVENTION

For this purpose, the subject of the invention is an electronic device module comprising a first connector mounted on one face of the module, the first connector being provided with electrical contacts each having an end internal to the module and an end external to the module, the external ends being designed to be plugged into a rack, the internal ends being designed to be soldered, wire-wrapped or crimped, the module furthermore including at least one plugged-in printed circuit card, the printed circuit card being electrically connected to the internal ends, characterized in that it includes a second connector that is rigidly fastened to the printed circuit card and is plugged into the internal ends.

Still other objects and advantages of the present invention will become readily apparent to those skilled in the art from the following detailed description, wherein the preferred embodiments of the invention are shown and described, simply be way of illustration of the best mode contemplated of carrying out the invention. As will be realized, the invention is capable of other and different embodiments, and its several details are capable of modifications in various obvious aspects, all without departing from the invention.

Accordingly, the drawings and description thereof are to be regarded as illustrative in nature, and not as restrictive.

### BRIEF DESCRIPTION OF THE DRAWINGS

FIG. 1 shows schematically the architecture of a module according to the invention;

FIG. 2 shows a perspective view of a connector intended to be fastened to a printed circuit card according to the invention; and

FIG. 3 shows two printed circuit cards plugged into the back of a module according to the invention.

### DETAILED DESCRIPTION

To make the description easier to read, the same reference numbers will denote the same elements in the various figures.

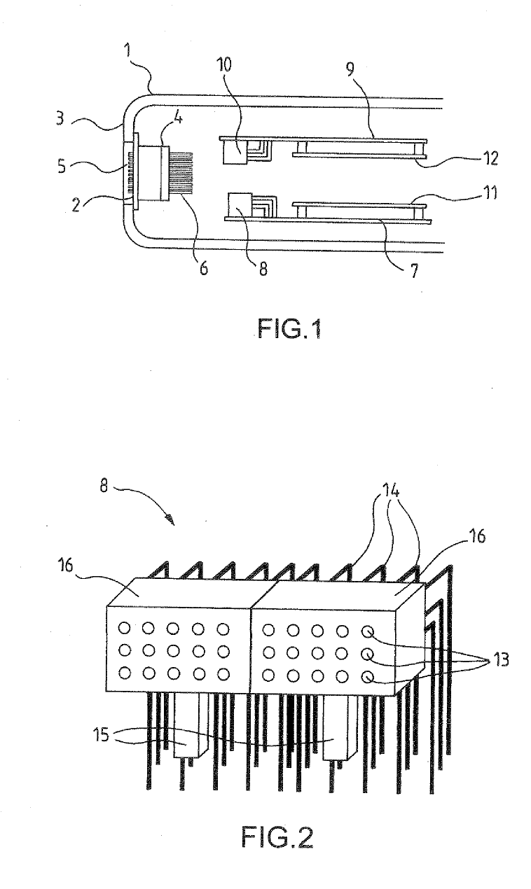

FIG. 1 shows part of an electronic device module 1 of parallelepipedal shape. The module 1 has an opening 2 located on one face 3 of the module 1 and a connector 4 mounted in the opening 2. The module 1 is intended to be plugged into a rack (not shown in FIG. 1). The rack includes a backplane connector into which the connector 4 is plugged.

Preferably, the connector 4 meets a specification belonging to the following list: ARINC 404a, ARINC 600, MIL 83 527.

The module 1 contains one or more electronic devices, the components of which are mounted on one or two printed circuit cards 7 and 9 placed so as to be parallel with the larger faces of the module 1.

The electronic device or devices, the components of which are mounted on the printed circuit card 7 and 9, exchange electrical signals with other electronic devices housed in other modules (not shown in FIG. 1) and consequently they have to be electrically connected, passing via the environment external to the module 1.

The connector 4 connects the inside and the outside of the module 1 by means of electrical through-contacts. Each electrical contact has two ends 5 and 6. One end 5, located outside the module 1, provides an electrical connection function with the environment external to the module, at the transition between the module 1 and the rack into which the module is plugged. An end 6, located inside the module 1, provides an electrical connection function with the card or cards 7 and 9 housed in the module 1. The ends 6 are designed to be irremovably fastened, i.e. the fastened ends cannot be disconnected without a tool, for example to be soldered, wire-wrapped or crimped.

A connector 8 rigidly fastened to one of the two sides of the card 7 provides the electrical connection between the ends 6 of the contacts of the connector 4 and the printed circuit card 7. The printed circuit card 7 is plugged directly into the ends 6.

Like the card 7, the card 9 supports, on one of its two sides, a connector 10 that plugs into the ends 6 of the contacts of the same connector 4. This allows two printed circuit cards to be plugged simultaneously into the same module and contributes to increasing the density of electronic devices in the module.

Advantageously, each of the cards 7 and 9 supports a daughter printed circuit cards 11 and 12, which is placed as a mezzanine card on that side of the cards supporting the connector 8 and 10. This also contributes to increasing the density of electronic devices in the module 1.

FIG. 2 shows the connector 8 comprising a body 16 of parallelepipedal shape and electrical contacts. Each electrical contact has two ends, namely an end 13 designed to be plugged into one of the ends 6 of the contacts of the connector 4 shown in FIG. 1, and an end 14 which is soldered to a printed circuit card, such as for example the card 7 shown in FIG. 1. The ends 13 are placed on one of the faces of the body 16 of the connector 8 with, for example, a regular horizontal and vertical spacing. The ends 14 of the contacts are soldered to the printed circuit card 7 with a regular pitch; they have a right-angled shape.

Advantageously, the connector 8 includes positioning means 15, for positioning on the printed circuit card to which it is fastened. These positioning means facilitate the operation of assembling the connector 8 on the printed circuit card, especially as regards connecting the ends 14 to the card 7. One example of positioning means comprises several pins of rectangular cross section that are inserted into holes provided for this purpose and made on the card 7.

Advantageously, the ends 13 of the contacts of the connector 8 are plugged into the ends 6 of the contacts of the connector 4 with a translational movement: the direction of this movement is normal to the face 3 of the module on which the connector 4 is mounted. In the module, access to the printed circuit card is facilitated by the fact that the direction in which the ends 13 of the contacts are plugged into the ends 6 of the connector 4 is also that by which the card is introduced into the module 1.

There is a large variety of connectors 4 that can be used for plugging modules into racks and that meet the above-mentioned specifications. These various connectors have common types of contacts and common arrangements of contacts—they differ only by the number of contacts that they contain. Rather than developing a complementary connector 8 for each existing connector 4, it is advantageous to develop a single modular connector 16 having a small, but skillfully chosen, number of contacts. By juxtaposing modular connectors 16, various connectors 8, the body of which is not monolithic, are thus produced. The various combinations of juxtaposed modular connectors 16 make it possible to constitute a family of connectors 8 complementary to all the connectors 4 that it is possible to encounter. The number of contacts that the modular connector 16 must have is for example given by the lowest common multiple of the numbers of contacts of the connectors 4 that can be used. In FIG. 2, two modular connectors 16 have been shown as an example.

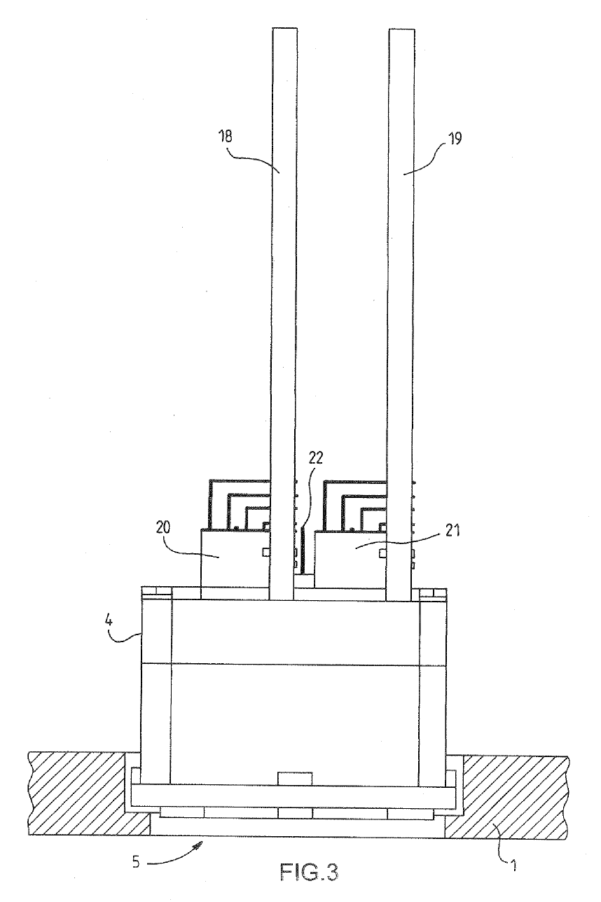

FIG. 3 shows a side view of the connector 4 of a module 1 that can be plugged into a backplane of a rack. The connector 4 comprises a body of parallelepipedal shape and electrical through-contacts connecting the inside of the module to the outside, these being organized in nine rows. Each of these contacts has two ends, namely an end 5 that is located toward the outside of the module, a function of which is to be plugged into a backplane connector of a rack (not shown in this figure) and an end 6 that is located toward the inside of the module, one function of which is to ensure connection with the printed circuit cards 18 and 19 housed parallel to each other in the module. The ends 6 are designed to be soldered, wire-wrapped or crimped.

Connectors 20 and 21 are fastened to one of the two sides of the cards 18 and 19—they comprise electrical contacts organized in rows, each row comprising several contacts. The contacts each have two ends: one end is designed to be soldered to the card 18 and 19—it has a right-angled shape—and the other end is designed to be plugged into the internal ends 6 of the connector 4. The number of rows of contacts is limited by the feasibility of the right-angled ends of the contacts. With more than four rows, the right-angled contacts are too long to be able to be produced without difficulty.

In FIG. 3, the connectors 20 and 21 each have four rows. Among the nine existing rows of ends 6, only a single row 22 is unused and exposed.

Advantageously, for the modular connector 16, the number of contacts per row is equal to the lowest common multiple of the number of contacts per row defined in the most common arrangements provided by the specifications relating to onboard connectors 4.

For example, the ARINC 600 and MIL 83 527 specifications stipulate arrangements of ten or fifteen contacts per row, which contacts are designed to be soldered to 22-gauge wires. For these specifications, a modular connector 16 having five contacts per row will be developed. This modular connector 16, assembled in twos or threes, makes it possible to use all the contacts of a row, irrespective of the arrangement chosen for the connector 4. Thus, only a single new connector will be developed, in this case the modular connector 16, which will allow printed circuit cards to be plugged into various arrangements of standard connectors 4.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by the definition contained in the appended claims and equivalent thereof.

1. An electronic device module, comprising:
a first connector mounted on one face of the module, said first connector being provided with electrical contacts each having an end internal to the module and an end external to the module, external ends being designed to be plugged into a rack, internal ends being designed to be soldered, wire-wrapped or crimped, the module furthermore including at least one plugged-in printed circuit card, said printed circuit card being electrically connected to said internal ends, and a second connector that is rigidly fastened to said printed circuit card and is plugged into said internal ends.

2. The module as claimed in claim 1, wherein the second connector is plugged into the internal ends of the contacts of the first connector in one direction that is normal to the face of the module on which the first connector is mounted.

3. The module as claimed in claim 1, wherein two second connectors, each fastened to a different printed circuit card, may be simultaneously plugged into the first connector.

4. The module as claimed in claim 1, wherein the printed circuit card has two sides, a side among the two sides supporting the second connector and also supporting a mezzanine daughter printed circuit card.

5. The module as claimed in claim 1, wherein the second connector includes positioning means, for positioning on the printed circuit card.

6. The module as claimed in claim 1, wherein the first connector meets a specification belonging to the following list: ARINC 600, MIL 83 527, ARINC 404A.

7. The module as claimed in claim 1, wherein the second connector is produced by juxtaposing modular connectors.

8. The module as claimed in claim 7, wherein the contacts of the modular connectors are organized in rows and the number of contacts per row is equal to the lowest common multiple of the number of contacts per row defined in the most common arrangements provided by the specifications relating to onboard connectors.

9. The module as claimed in claim 2, wherein two second connectors, each fastened to a different printed circuit card, may be simultaneously plugged into the first connector.

10. The module as claimed in claim 2, wherein the printed circuit card has two sides, a side among the two sides supporting the second connector and also supporting a mezzanine daughter printed circuit card.

11. The module as claimed in claim 2, wherein the second connector includes positioning means, for positioning on the printed circuit card.

12. The module as claimed in claim 2, wherein the first connector meets a specification belonging to the following list: ARINC 600, MIL 83 527, ARINC 404A.
